(19) United States
(12) Patent Application Publication
(10) Pub. No.: US 2012/0187352 A1
(43) Pub. Date: Jul. 26, 2012

(54) Penetrating UV-Protecting Compositions to Protect Wood and Lignin

(75) Inventors: Karoly Donders, Ostermundigen (CH); Hansruedi Mottl, Oftringen (CH); Otto Gordon, Apples (CH)

(73) Assignee: ISP INVESTMENTS INC., Wilmington, DE (US)

(21) Appl. No.: 13/257,511

(22) PCT Filed: Mar. 22, 2010
(86) PCT No.: PCT/US10/28123

§ 371 Date: Apr. 16, 2012

Related U.S. Application Data
(60) Provisional application No. 61/164,519, filed on Mar. 30, 2009.

(51) Int. Cl. G02B 5/22

(52) U.S. Cl. 252/589

(57) ABSTRACT

Disclosed herein are compositions for protecting a substrate against UV damage that comprise UV absorber(s), microemulsifier(s), polyol(s), and a water-based vehicle. In preferred embodiments, the compositions find application to protect lignin from degradation, or as primer coatings for wood surfaces, especially for use under UV-curable coatings. In other preferred embodiments the compositions are free of any film-forming polymer.

### FIELD OF THE INVENTION

This invention describes water-based, penetrating compositions applied on substrates to prevent damage from ultraviolet (UV) radiation, wherein the composition comprises UV absorber(s), microemulsifier(s), polyol(s), and a water-based vehicle.

In preferred embodiments, the compositions find application to protect lignin from degradation, and as primer coatings for wood surfaces, especially for use under UV-curable coatings.

### DESCRIPTION OF PRIOR ART

Wood is a ubiquitous building material, used throughout the world to construct innumerable objects such as building materials, houses, frames, furniture, planks, plywood, and shingles. Numerous woods are used for building and construction material and furniture. Wood is a complex biopolymer composed of numerous constituents, such as cellulose, hemi-cellulose, lignin, and resin. Lignin, an aromatic polymer of repeating phenyl-propanol units, is the structural agent that imparts strength to wood.

Although wood is very versatile and attractive, it is highly susceptible to undesirable changes upon the photo-absorption of ultraviolet (UV) radiation and visible light. This absorption can result in two primary changes to wood that are the focus of this invention: the yellowing of wood, and the cracking of lignin.

In the first case, photo-absorption initiates the oxidation of lignin, a hydrophobic (water-insoluble), natural polymer with a complex and heterogeneous structure that includes phenolic groups, double bonds, carbonyl groups, quinine groups, and biphenyl groups. Lignin is a strong absorber of both UV radiation and visible light, and photo-absorption can excite the molecule to a higher energy state. If the energy cannot be dissipated (e.g., by heat, fluorescence or phosphorescence), then chemical reactions can be initiated. For example, phenol and assorted ethers in lignin can be oxidized to yield yellow o-quinone compounds. Due to the chromophoric shift of these molecules, there is a pronounced yellow color change. Although yellowing may be considered to be primarily a cosmetic problem, it is the first step of lignin degradation. Nonetheless, there exists a need to reduce or even eliminate the yellowing of wood, especially for applications where the color change is aesthetically unappealing.

Photo-absorption also can result in the more serious problem of lignin cracking, meaning the scission or cleavage of the lignin molecule into smaller molecular parts. When lignin is cracked, the degradation imparts water-solubility to the otherwise water-insoluble lignin molecule. Anatomical, chemical, surface, and structural changes are facilitated when lignin-degraded wood is exposed to water, and can lead to cosmetic and mechanical damage. Since lignin is the structural “glue” in wood, an affected wood surface may exhibit substantial loss of wood constituents, leading to cracking and grooving. Even worse, the water-soluble, degraded constituents support fungal growth, which often is manifested as a blue or black stain on affected wood.

It is important to recognize that anti-yellowing compositions may not provide effective protection against photo-induced scission to the lignin molecule. Consequently, in addition to protecting against yellowing, compositions and methods are desired that effectively prevent UV-induced damage to lignin.

Transparent, pigmented and colored lacquers for wood are very popular for interior and exterior application. Additionally, they may contain UV absorbers. Although such lacquers, especially clear topcoats, permit wood color and surface structure aesthetics to be visible, they do not provide effective protection against lignin degradation. Because the UV absorbers are constrained atop the wood in the coating layer, the UV absorbers are too removed from the wood surface to protect from UV damage, especially the degradation of lignin. Thus, the IN absorbers contained in the topcoats protect the topcoat from yellow and other photo-induced damages. The wood vulnerable to UV damage, especially the top cell layer which may result in delamination of the coating and further wood deterioration.

Prior art teaches the use of light stabilizers to protect against photo-absorption changes in wood. For example, patent application WO 2007/051741 discloses the color stabilization of cork and dark-colored wood through the use of inorganic and organic UV absorbers. An electron beam-curing coating is taught in JP 2002/069331 that contains an acrylic monomer, a triazine UV absorber, and a hindered amine photostabilizer. U.S. Pat. No. 5,747,162 teaches compositions comprising terpene and/or vitamin antioxidants and a film-forming material capable of forming a substantially uniform continuous coating on the substrate. Such compositions are used to coat substrates to prevent their degradation.

German patent DE 10041616 discloses the preparation of a UV-protection coating layer that comprises: (1) one or more layer-forming polymers, (2) UV absorbers dissolved, dispersed, or emulsified in the polymer(s), and (3) one or more solvent. The formulations are suitable for layer application by various methods.

U.S. patent application 2003/150358 provides aqueous waterproofing compositions that optionally contain UV absorbers.

An aqueous coating is described in WO 2006/093916 that comprises an organic phase with a substrate coating resin, an emulsifier, and an aqueous phase. The term “substrate coating resin” is defined to encompass hydrophobic resins that can be incorporated into aqueous compositions for coating a substrate, and include materials like silicone-modified polymers, perfluorinated polymers, and chlorinated polyolefins. The use of water-soluble polyols without the inclusion of hydrophobic resins is not provided.

Swiss patent CH 697,424 discloses anti-yellowing formulations for wood that contain a water-soluble UV absorber and a water-soluble photostabilizer for lignin. Related commercial products are SunCare® 800, SunCare® 900, and SunCare® Concentrate, which are sold by International Specialty Products (Wayne, N.J.). SunCare® Concentrate is an additive for woodcare products, with typical use levels of 4%-12%. SunCare® 800 is finished product, meaning for application to untreated wood as supplied, that was developed for interior applications. SunCare® 900 also is a finished product and contains Fungitrol® B10 to prevent fungal growth; it is intended for exterior application, as it. These effective products contain a radical scavenger, which can interfere with UV-curable topcoats.

While products have been developed for wood, they do not adequately protect the constituents of wood, such as lignin, from UV-induced damage. Wood use, particularly in exterior applications for construction and design, would greatly benefit from compositions that protect wood integrity, especially compositions with reduced maintenance work. Accordingly, it is an object of this invention to provide a penetrating composition that protect wood from UV-induced damage, especially lignin degradation and discoloration, and can be used under UV-curable topcoats.

### SUMMARY OF THE INVENTION

Described herein are penetrating compositions to protect substrates against UV-induced damage and discoloration, especially photo-induced scission to the lignin molecule. The water-based compositions comprise at least one benzotriazole UV absorber and/or one triazine UV absorber, a microemulsifier, a polyol, and a water-based vehicle.

In preferred embodiments, the wood-penetrating compositions are applied as a primer prior to one or more UV-curable topcoating layers.

### DETAILED DESCRIPTION OF THE INVENTION

Surprisingly, wood and lignin protection from UV radiation has been discovered using penetrating compositions that comprise (a) a UV absorber, (b) a microemulsifier, (c) a polyol, and (d) a water-based vehicle.

Unlike compositions known in the prior art that present the UV absorber in a particulate dispersion, in a nonaqueous-based vehicle, or in a film-forming coating layer that resides atop the substrate, the discovered water-based compositions penetrate into the wood substrate, providing intimate contact of the active ingredients with the substrate's constituents, especially lignin. By protecting lignin in situ from degradation, its water-insolubility is significantly maintained and it is not significantly leached, washed away, or attacked by fungi. Topcoat(s) applied thereon exhibit substantially reduced tendency to crack, peel, and/or separate from the protected, coated substrate.

In preferred embodiments the UV-protecting compositions do not contain a radical scavenger. Thus, the disclosed compositions are valuable as a primer to UV-curing coatings and coatings containing oxidative drying binders, both of which are negatively affected by radical scavengers.

Additionally, because the compositions are water-based, the volatile organic carbon (VOC) emissions from the coatings are substantially reduced and/or negligible compared to solvent-borne coatings.

It is preferred, but not required, that the water-based vehicle consist essentially of water. In highly preferred embodiments, the water-based vehicle is water.

The invention also provides methods to protect substrates from lignin degradation and yellowing by coating the substrate with an effective amount of the UV-protecting compositions. In preferred embodiments the compositions are applied to wood substrates such as, but not limited to: building materials, houses, frames, furniture, planks, plywood, and shingles. While wood is an exemplary substrate, this method finds relevance to protecting other substrates from UV damage, including: natural and synthetic fabrics, fibers, and plastics.

In yet another embodiment, the invention describes the use of the UV-protecting compositions to protect substrates from lignin degradation and yellowing.

### UV Radiation Absorbers

UV absorbers that find utility in the protecting compositions are those materials that absorb electromagnetic radiation with a wavelength from about 100 nm to about 400 nm, and includes the UV-A, UV-B, and UV-C sub-classifications of such radiation. It is especially preferred that the UV absorber(s) used in compositions of this invention absorb radiation from about 280 nm to about 380 nm, as this range of UV radiation is particularly damaging to wood, and, more specifically, lignin. It will be appreciated by those skilled in the art that these materials also naturally absorb radiation outside this range, so that other categories of electromagnetic radiation (e.g., visible light) also may be absorbed.

The term “UV-A” means ultraviolet electromagnetic radiation with a wavelength from about 320 nm to about 400 nm, and includes UV-A1 (from about 340 nm to about 400 nm) and UV-A2 (from about 320 nm to about 340 nm). The term “UV-B” means ultraviolet electromagnetic radiation with a wavelength from about 290 nm to about 320 nm. The term “UV-C” means ultraviolet electromagnetic radiation with a wavelength from about 200 nm to about 290 nm. Blends of UV absorbers may be required, and even desirable in order to provide protection against lignin degradation and yellowing.

As described earlier, superior UV protection is imparted in situ into the substrate and its constituents (e.g., lignin), in contrast to compositions of the prior art that layer the UV absorber on top. To achieve substrate penetration, it is essential that the UV absorber(s) be dissolved and/or presented in a microemulsion so that the active ingredient contact the lignin molecule.

Many different chemical classifications of UV absorbers are known, and include: anthranilates, benzophenones, benzotriazoles, camphors, cinnamates, dibenzoyl methane, imidazoles, inorganic particulates, malonates, para-aminobenzoic acids, phenols, phenyl triazines, quinones, salicylates, and triazones. UV absorbers and blends of UV absorbers that satisfy the requirements stated above can be identified by one skilled in the art. In highly preferred embodiments, the UV absorber comprises a blend of a benzotriazole and a triazine.

A suitable method to select the UV absorber(s) for use in this invention is to test UV transmission, i.e., through a 1 cm cell, of a toluene solution containing a concentration of 40 mg/L of the test UV absorber(s). Suitable UV absorber(s) and blends of LTV absorbers are those that transmit 10% or less of wavelengths between 280 nm and 380 nm, and particularly wavelengths between 340 nm and 380 nm.

Preferred UV absorbers include those chemicals of the benzotriazole and triazine families.

One such preferred UV absorber is Tinuvin® 99-2, a benzotriazole UV absorber sold into commercial applications by Ciba Specialty Chemicals (Basel, Switzerland). The chemical name of Tinuvin® 99-2 is 3-(2H-benzotriazol-2-yl)-5-(1,1-dimethylethyl)-4-hydroxy-benzenepropanoic acid, C7-9-branched and linear alkyl esters. Tinuvin® 99-2 absorbs UV radiation, especially UV-A radiation, i.e., from about 340 nm to about 380 nm. This product is sold and may be used in the supplied liquid vehicle carrier, i.e., 2-methoxy-1-methylethylacetate.

Another preferred UV absorber is Tinuvin® 477, a hydroxyphenyl triazine UV absorber that also is sold by Ciba Specialty Chemicals. Tinuvin® 477 is a broad band absorbing UV absorber with high extinction in the UV-A range, i.e., from about 320 nm to about 390 nm. This product is sold and may be used in the supplied liquid vehicle carrier, i.e., 2-methoxy-1-propylacetate.

Alternatively, and preferred in some embodiments, the UV absorber is a blend of two or more UV absorbers, especially those based on the benzotriazole and triazine families. One such preferred, blended UV absorber product is Tinuvin® 5236, a commercial product of Ciba Specialty Chemicals (Basel, Switzerland) that is a blend of Tinuvin® 99-2 and Tinuvin® 477. By combining both UV absorbers into a single UV absorbing product, Tinuvin® 5236 offers broad UV-spectrum for wood and lignin protection, and may facilitate raw material ordering, inventory, formulation development and formulation production. The UV-protecting formulation does not comprise an radical scavenger, which would otherwise interfere with the UV-curable topcoats and coatings containing oxidative drying binders.

### Microemulsion

The UV-protecting compositions are formulated with one or more microemulsifiers to present the UV absorber(s) in a dispersion, preferably a nanodispersion, so that they penetrate and contact wood's constituents. Microemulsions normally consist of an aqueous phase, an oil phase, and a surfactant phase. Unlike emulsions, microemulsions spontaneously form to create clear and thermodynamically stable microemulsions that do not coalesce and/or settle with time. Methods of characterizing microemulsions are known, such as the description provided in Applications of Microemulsions, Surfactant Series, vol. 66 (ed.: C. Solans and H. Kunieda); Marcel Dekker, New York, 1997, which herein is incorporated in its entirety by reference.

Presenting the active(s) in a microemulsion offers a distinct advantage over those known in the prior art. In addition to their stability, microemulsions present the active on a colloidal scale, less than 1000 nm, and typically less than 100 nm, and most preferably, less than 30 nm. Hence, microemulsions may appear to be optically clear, since the dispersed particle component(s) are smaller than the size that refracts visible light. Without being bound to specific theory, it is believed that water-based microemulsions of active ingredient(s) better penetrate the substrate and contact its constituents. In the case of wood, the active(s) may enter the pores and protect lignin in situ. As lignin is not degraded, this binding agent that ties together the cell-fibers in the wood is maintained. The wood remains undamaged and so paint or varnish can stay much longer on the wood surface.

One preferred family of microemulsifiers is the Microflex® line of products of International Specialty Products (Wayne, N.J.), and in particular, Microflex® NX, which is described in US patent application 2008/0081059, which herein is incorporated in its entirety by reference. Another preferred microemulsifier is Bomol® 4N, a maleated linseed oil, also sold by International Specialty Products.

### Polyol

Additionally, the water-based compositions comprise a polyol. Without being bound by any particular theory, it appears that the hydroxyl content of the polyol assists the composition's UV-absorbing performance by reacting with the formed C-centered radicals, thereby acting as an organic radical scavenger. In this role the polyol serves as a UV-active ingredient in addition to the UV absorber(s).

Suitable polyols include, but are not limited to: ethylene glycols, glycerol, methoxy-poly(ethylene glycols), poly(ethylene glycols), poly(ethylene glycol methacrylate), propylene glycols, and sorbitol. Thus, both natural and synthetic, monomeric and polymeric polyols are contemplated.

An especially preferred polyol is poly(ethylene glycol). Examples of commercially available poly(ethylene glycols) include the Carbowax™ series by The Dow Chemical Company (Midland, Mich.), which have average molecular weights from 190 amu to 9000 amu.

A range of polyol molecular weight can be identified so that exemplary performance is attained in the UV-protecting compositions. If the polyol molecular weight is too low, it may degrade and contribute a yellow color to the coated substrate, which may be aesthetically undesirable. Conversely, excessively high polyol molecular weight impedes penetration of the UV-protecting composition into the substrate, and instead the composition forms a layer that substantially does not penetrate the substrate. Understandably, the exactly molecular weight depends on the formulation details, such as UV absorber(s), microemulsifier(s), and solids content. Generally speaking, the polyol molecular weight ranges from about 200 atomic mass units (amu) to about 600 amu, and more preferably from about 300 amu to about 500 amu. Examples of exemplary poly(ethylene glycols) include: Carbowax™ 400, 540, and 600 of The Dow Chemical Company (Midland, Mich.).

### Water-Based Vehicle

A water-based vehicle constitutes the carrier for delivering the protecting compositions of this invention. The term “water-based” means a liquid carrier is used to deliver the active ingredients, viz., the UV absorber(s) and polyol. In particular, this water-based vehicle contains at least 10% water. In preferred embodiments, the water-based vehicle comprises at least 50% water, and in highly preferred embodiments, the water-based vehicle is 100% water.

There is no constraint as to the type of water that may be used, as long as the end product imparts the desired UV-protecting properties. For example, water may be used that has been pretreated, e.g., degassed, deionized, distilled, filtered, and/or passed through ion exchange media.

The water-based vehicle also may comprise additives that assist the application and/or performance of the performance of the protecting composition. Examples of suitable additives include, but are not limited to: anti-bacterial agents, anti-fungal agents, defoamers, detergents, insecticides, lubricants, mildewcides, surfactants, waxes, and wetting agents. These additives, which are described in greater detail in a later section, may be chelated, dispersed, dissolved, distributed, emulsified, solubilized, and/or mixed in the water-based vehicle.

Alternatively, but still within the scope of the invention, the water-based vehicle comprises one or more non-aqueous vehicles. The only provision is that the final composition be sufficient to substantially penetrate the substrate. A general rule is that the delivery vehicle contain at least 10% water. Examples of appropriate non-aqueous vehicles include, but are not limited to: amyl acetate, butanol, butyl acetates, ethanol, methyl ethyl ketone (MEK), glycols, glycol ethers, methanol, methyl isobutyl ketone (MIBK), mineral spirits, naphtha, 1-propanol, 2-propanol, toluene, and xylene. Solvent commonly used in waterborne coatings include: butanol, glycol, glycol ethers, and propanols.

### Composition and Usage Levels

Compositions produced by this invention comprise, by weight:
from about 1% to about 10% of UV absorber,
from about 1% to about 30% of microemulsifier,
from about 1% to about 60% of polyol,
from about 20% to about 80% water, and
from about 1% to about 20% total solids.

More preferably, the compositions comprise:
from about 2% to about 8% of LTV absorber,
from about 5% to about 30% of microemulsifier,
from about 10% to about 50% of polyol,
from about 40% to about 60% water, and
from about 1% to about 15% total solids.

In especially preferred embodiments, the compositions produced by this invention comprise:
from about 3% to about 5% of UV absorber,
from about 10% to about 20% of microemulsifier,
from about 20% to about 50% of polyol,
from about 30% to about 50% water, and
from about 5% to about 15% total solids.

The application of these compositions to the substrate are such that effective coverage is attained. Typically, the compositions are applied at a usage rate of from 2 grams per square meter to about 20 grams per square meter.

### Optional Components

As briefly mentioned earlier, it is within the scope of this invention that optional components may be added to the UV-protecting composition. The only limitation of such optional ingredients is that they not render the composition ineffective in providing protection from UV and/or visible light.

### UV Absorbers

In addition to comprising a benzotriazole and triazine UV absorbers, compositions of the invention also may contain additional UV absorbers, whose general absorption ranges were defined earlier. Such UV absorbers may be water-soluble and/or emulsified with the light stabilizer blend. Non-limiting examples of water-soluble UV absorbers include: (Tinuvin® 595), tetradibutyl pentaerithrityl hydroxyhydrocinnamate (Tinogard® TL), sodium benzotriazolyl butylphenol sulfonate (Tinogard® HS), tris(tetramethylhydroxypiperidinol) citrate (Cibafast® H Liq), terephthalylidene dicamphor sulfonic acid (Mexoryl® SX), para-aminobenzoic acid (PABA), benzophenone-5, benzophenone-9, trolamine salicylate, and, phenylbenzimidazole sulfonic acid. Especially preferred UV absorbers include: Tinuvin® 595.

It is noted that Tinogard® TL, Tinogard® HS, and Cibafast H Liq. all exhibit broad-spectrum absorption of UV-A and UV-B wavelengths. The UV absorbers effective water solubility, offering protection in the water-based vehicle.

### Lubricants

Useful lubricants include cationic, non-ionic or anionic lubricants and mixtures thereof. The amount of lubricant can be about 0.0001% to about 99.9% (w/w) of the composition on a total solids basis, preferably about 0.01% to about 50% (w/w), and more preferably about 0.1% to about 10% (w/w).

Non-limiting examples of such lubricants are glass fiber lubricants which include amine salts of fatty acids (which can, for example, include a fatty acid moiety having 12 carbon atoms to 22 carbon atoms and/or tertiary amines having alkyl groups of 1 atom to 22 atoms attached to the nitrogen atom), alkyl imidazoline derivatives (such as can be formed by the reaction of fatty acids with polyalkylene polyamines), acid solubilized fatty acid amides (for example, saturated or unsaturated fatty acid amides having acid groups of 4 carbon atoms to 24 carbon atoms such as stearic amide), acid solubilized polyunsaturated fatty acid amides, condensates of a fatty acid and polyethylene imine and amide substituted polyethylene imines.

### Plasticizer

The compositions can also include one or more aqueous dispersible or soluble plasticizers. Examples of suitable non-aqueous-based plasticizers which are aqueous dispersible include phthalates, such as di-n-butyl phthalate; trimellitates, such as trioctyl trimellitate; and adipates, such as dioctyl adipate. The amount of plasticizer can be about 0.01% to about 20% (w/w) of the composition on a total solids basis, and is more preferably about 0.1% to about 10% (w/w).

Examples of useful humectants include glycerols such as are commercially available from The Dow Chemical Co. (Midland, Mich.). The amount of humectant can be about 0.01% to about 20% (w/w) of the composition on a total solids basis, and is more preferably about 0.1% to about 10% (w/w).

### Emulsifiers/Microemulsifiers

Non-limiting examples of suitable emulsifying/microemulsifying agents or surfactants include polyoxyalkylene block copolymers, ethoxylated alkyl phenols, polyoxyethylene octylphenyl glycol ethers, ethylene oxide derivatives of sorbitol esters and polyoxyethylated vegetable oils.

An example of a suitable polyoxypropylene-polyoxyethylene copolymer is the material Pluronic™ F-108, which is commercially available from BASF Corp. (Ludwigshafen, DE). This material is a condensate of ethylene oxide with hydrophobic bases formed by condensation of propylene oxide with propylene glycol.

Examples of useful ethoxylated alkyl phenols include ethoxylated octylphenoxyethanol, phenoxy polyethylene-oxy(ethanol), phenoxy(ethyleneoxy)ethanol and nonyl phenoxy poly(ethyleneoxy)ethanol.

An example of a polyoxyethylated vegetable oil is Emulphor® EL-719, which is commercially available from BASF Corp. (Ludwigshafen, DE). A useful polyoxyethylene octylphenyl glycol ether is Triton® X-100, which is commercially available from The Dow Chemical Co. (Midland, Mich.). Tween® 21 and Tween® 81 are examples of useful ethylene oxide derivatives of sorbitol esters.

Generally, the amount of emulsifying agent can be about 0.01% to about 20% (w/w) of the composition on a total solids basis, and is more preferably about 0.1% to about 10% (w/w).

### Colorants

Useful colorants or pigments include those that impart desirable qualities to the coated substrate, e.g., to augment or highlight the natural color and/or graining of wood, or to obscure the natural surface. Colorants include nigrosine and cadmium-based, iron oxide-based chromium compounds. The amount of colorant on a total solids basis can be about 1×10⁻⁴% to about 10% (w/w), and more preferably about 0.001% to about 5% (w/w).

Examples of antistatic agents useful in the present invention include Larostat® 264 alkyl dipolyoxyethylene ethyl ammonium ethyl sulfate which is commercially available from BASF Corp. (Ludwigshafen, DE). The amount of antistatic agent can be about 1×10⁻⁴ to about 10% (w/w), and more preferably about 0.001% to about 5% (w/w) of the composition on a total solids basis.

### Waxes

The compositions can also include one or more aqueous soluble, emulsifiable or dispersible waxes. The wax can be selected from vegetable, animal, mineral, synthetic or petroleum waxes, for example. Preferably, the wax has a high degree of crystallinity and is obtained from a paraffinic source, such as a microcrystalline wax. Other useful microcrystalline waxes are commercially available from Baker Petrolite (Sugar Land, Tex.) and Michelman, Inc. (Cincinnati, Ohio). The amount of wax can be about 1×10⁻⁴ to about 5% (w/w) of the composition on a total solids basis.

### Fungicides, Bactericides

Fungicides, bactericides and anti-foaming materials can also be included in the compositions. Examples of suitable bactericides include the Fungitrol®, Irgarol®, and Nuosept® products lines of International Specialty Products (Wayne, N.J.). The amount of fungicide or bactericide can be about 1×10⁻⁴ to about 5% (w/w) of the composition on a total solids basis.

### Anti-Foamers, Defoamers,

It may be advantageous to include an additive into the UV protecting composition to reduce and/or eliminate the formation and persistence of bubbles and/or foams. Examples of commercial anti-foamer/defoamers include the Dowfax™ and Tergitol™ products sold by The Dow Chemical Company (Midland, Mich.).

### Acids/Bases

The compositions can further comprise one or more acids and/or bases in an amount sufficient to adjust the pH as needed.

Non-limiting examples of acids include: mono-and polycarboxylic acids and/or anhydrides thereof, such as acetic, citric, formic, propionic, caproic, lactic, benzoic, pyruvic, oxalic, maleic, fumaric, acrylic, methacrylic acids and mixtures thereof.

Non-limiting examples of bases include: ammonia, calcium hydroxide, methylamine, magnesium hydroxide, pyridine, sodium hydroxide, and potassium hydroxide.

### Coatings

It is within the scope of the current invention that the wood-protecting compositions find application as stand-alone, wood-penetrating coatings, and as primer coatings. As used herein, the term “stand-alone” means further applications of any kind of material are not applied, while the term “primer” means one or more further applications of any kind of material are applied. Many different coatings are known in the art for application to wood, for aesthetic, functional, and aesthetic and functional purposes. Seal-coats are known, which serve as a barrier between two layers.

The primer is the first film of coating applied in a coating operation that may facilitate bonding between the surface and subsequent coats. Primer coatings of this invention serve to impart UV and/or light protection of the wood-containing material from discoloration and/or lignin degradation. Without adequate primer adhesion to the surface, subsequent coatings may not adhere properly. Primers also may prevent dulling of the topcoat caused by the penetration of topcoat solvents into the lower coat(s). If imperfections remain on the surface after primer application, a primer surface may be applied to build thickness and smooth over any imperfections. Prime coatings of this invention was borne in a water-based vehicle that contain little or no organic solvent.

The intermediate coat serves to seal the primer and fill any voids or porosities in the primer coat. They also provide an additional layer of corrosion protection by acting as a barrier coat. An intermediate/midcoat also provides a surface to which subsequent coats can adhere. In instances where a primer and a topcoat are not compatible (such as a thin film topcoat and a zinc-filled primer), intermediate coats can serve as a tie coat between the two coats.

Topcoats also are known being the final film of coating applied after a surface has been prepared and is free of defects. Topcoats may provide the final color and appearance. They also may provide additional resistance to the environment and help protect the primer and intermediate coats from exposure to weather and chemicals. Topcoats may be single-, two-, or three-stage coating systems. An oven bake may follow each topcoat application, or the coating may be applied wet on wet. The final topcoat may be baked in a high-temperature oven. Two-stage systems may have either a solid color or metallic basecoat, covered with a transparent clearcoat for protection. These systems are eye-appealing because of their deep, rich finish. Three-stage systems consist of a basecoat, midcoat, and clearcoat. Topcoats have traditionally been solventborne lacquers and enamels. Recent trends have been to use topcoats with higher solids content, such as powder topcoats and may impart desirable properties to the wood-containing material, including, but not limited to: abrasion resistance, gloss, stain resistance, surface wear, toughness, and/or water resistance. Coatings may be applied many different ways, such as on a flat line, using roll coaters or curtain coaters, in water, solvent, or water/solvent vehicles, and can contain up to 100% solids.

Coatings that typically contain greater than 60% solids by volume are referred to as high solids coatings (Environmental Protection Agency [EPA], 1992). High-solids coatings require less solvent content, therefore, volatile organic compound (VOC) emissions reductions ranging from 50% to 80% can be achieved by converting to coatings that contain higher solids. High solids coatings can be applied electrostatically or manually by roll coating or spraying. Because of the higher viscosity of high-solids coatings, additional mechanical, thermal, or electrical energy may be necessary for pumping and adequate atomization. Transfer efficiencies are usually better than those achieved through conventional coatings, especially when sprayed electrostatically. In addition, because there is less solvent in high-solids coatings, the minimum air flow required for dilution of air in a spray booth may be reduced, resulting in an energy savings for fan operation.

Urethanes are thermoset topcoatings formed by a chemical reaction between a hydroxyl-containing material and a polyisocyanate catalyst. Urethane coatings have a higher volume percentage of solids content than lacquers and a slightly higher percentage than enamels. Urethane coatings are popular because of their superior gloss retention, durability, corrosion protection, and versatility. This coating type is strongly adherent to metal surfaces and can resist both chemical attack and abrasion. Their clarity and resistance to weather make them valuable for severe industrial service. Urethane coatings dry more slowly than lacquer or enamel coatings and, because of the slower drying time, spray booths are often required to provide a clean, dustfree curing environment.

Enamels are thermoset topcoatings that can be either acrylic- or alkyd-based. Acrylic enamels require catalysts to facilitate curing. An alkyd enamel is a mixture of an alcohol, an acid, and an oil. Both types have a natural high gloss. Enamel coatings have a longer drying time than lacquer coatings.

Lacquers are thermoplastic topcoatings that dry faster than most enamels and urethanes, making them more attractive to sources (e.g., automobile body shops) that do not have spray booths. Lacquer finishes, however, are not as durable as enamel and urethane finishes.

Powder coatings are applied electrostatically by spraying or dipping, or by dipping a preheated object into a fluidized bed of coating. After a powder coating is applied to an object, the object is placed in an oven to melt the powder particles and create a flow to form a continuous, solid film. Electrostatic powder spray coating can be performed automatically or manually. As charged powder particles leave a spray gun, they are attracted to the grounded object that is to be coated. With this method, powders are able to wrap around edges of complicated forms. Film thickness can be controlled by adjusting the voltage. Like conventional spraying, powder spraying requires a booth. However, the ventilation requirements for powder spray booths are much less stringent than for solvent coating spray booths if the powder is applied automatically and the booth is, therefore, not occupied. Dipping is also used to apply powder coatings. There are two ways that powders can be applied by dipping: fluidized bed or electrostatic fluidized bed. In a fluidized bed, a preheated object is immersed into the bed and held there until a desired film thickness is reached. In electrostatic fluidized bed coating, the powder particles are attracted to grounded, usually unheated, objects moving through the bed. A disadvantage of dipping is that powder coatings can only be applied in thick films. Although powders are essentially 100% solids, they may produce small quantities of organic materials which may be released during the curing process. Up to 5% of VOCs can be released from powders during this process (RTI 2000). Most powder overspray can be reclaimed and reused; however, some reclaimed overspray must be reprocessed because it may contain larger and heavier granules that are not acceptable for reuse.

Coatings that are based on vinyl resins formed by the polymerization of vinyl compounds are called vinyl coatings. The most common resins are based on polyvinyl chloride (PVC) copolymers. These resins form films by solvent evaporation. Freshly applied coatings are dry to the touch within one hour and are fully dried within seven days. Vinyl coatings are particularly useful when fast drying, particularly at low temperatures (0° C. to 10° C. [32° F. to 50° F.]), is required. Coatings based on vinyl polymers perform well in immersion situations and are frequently used to protect submerged structures such as the underwater hull of a ship. These coatings have excellent resistance to many chemicals and are good weather-resistant materials. Vinyl coatings are softened by heat and are not suitable for sustained use above 66° C. (150° F.). Vinyl paint systems require the use of a thin coat of wash primer (containing acids to etch the surface) as the first coat to ensure good adhesion to steel.

In one preferred embodiment, the wood-protecting composition comprising a water-soluble UV absorber and a water-soluble radical scavenger finds application as a primer coating under a non-UV-cured topcoat. Topcoats that are not UV-cured are well known throughout the field, and include compositions based on, but not limited to: acrylates, alkyds, drying oils, polyurethanes, and shellacs.

In another embodiment of the invention, the wood-protecting compositions of this invention may be employed as a primer coating under one or more UV-cured coatings. In addition to other coating ingredients, these coatings contain photoinitiators that cleave to yield free radicals that begin a polymerization of coating materials. UV-cured coatings may be applied by brushing, dipping, rolling, and/or spraying. Such coatings may exhibit little or no volatile organic carbon emissions. However, sprayable, UV-cured coatings may contain water or solvent to reduce the viscosity of the coating for easier application. Spray booths for UV-cured coatings generally are enclosed and automated. A curing oven follows the coating applicator and contains UV lamps that cure the coating in a matter of seconds. Since the cure time is so short, pieces can be assembled and stacked immediately after they are coated. The appearance of a UV-cured finish is typically aesthetically pleasing and very durable. High-gloss finishes can be easily achieved by applying either multiple coats or thicker coats. The clarity and depth of the finish can be comparable to that of traditional nitrocellulose-based coatings.

In order to avoid incompatibilities with the UV-cured topcoat, it is desirable that the wood-protecting composition not contain a radical scavenger.

### Coating Application

### Brush Coating

Coating applied with a brush is called brush coating. A transfer efficiency of 100% may be achieved using this method. Brush coating may be a preferred consumer method for applying the described penetrating compositions.

However, brush coating may not a practical method for industrial use wherein the compositions need to be applied on many pieces. As such other application techniques may be preferred.

### Dip Tanks

Objects to be coated are immersed manually or by conveyor into a dip tank full of coating. After removal from the tank, any excess coating is allowed to drain back into the tank. Dip coating operations can be totally enclosed and vented by a roof exhaust system, or may have a ventilation system adjoining the dip tank. The advantages of dip coating include minimal coating loss. Dip coating operations are common (but not limited) to the following industries; metal furniture, miscellaneous metal parts, aircraft, appliances, automobiles, and light-duty trucks.

### Flow Coating

Flow coating is a coating process by which the object to be coated is conveyed over an enclosed sink where pumped streams of coating are allowed to hit the object from all angles, flow over the object and coat it, and drip back into the sink. Typically, a series of nozzles (stationary or oscillating) are positioned at various angles to the conveyer, and shoot out streams of coating that “flow” over the object. Flow coating can achieve up to 90% transfer efficiency. Examples of industries using flow coating include automobile, flat wood paneling, metal furniture, and miscellaneous metal parts. “Vacuum coating” is a kind of flow coating. The coating chamber is flooded with coating and vacuum pulls the coating across the product. “Curtain coating” is also a type of flow coating. In this process, the coating is not pumped from all angles but instead cascades over the part as a waterfall. Curtain coating is used mostly for flat goods.

### Roller Coating

Roller coating machines typically have three or more power-driven rollers. One roller runs partially immersed in the coating and transfers the coating to a second, parallel roller. The strip or sheet to be coated is run between the second and third roller and is coated by transfer of coating from the second roller. If the cylindrical rollers move in the same direction as the surface to be coated, the system is called a direct roll coater. If the rollers move in the opposite direction of the surface to be coated, the system is a reverse roll coater (EPA, 1995a). The quantity of coating applied to the sheet or strip is established by the distance between the rollers.

### Spray Booths

Spray booths provide a clean, well-lit, and well-ventilated enclosure for coating operations. Coatings that have long drying times are best applied in spray booths to minimize potential dust and dirt from adhering to a wet coating. Some spray booths are equipped with a heating/baking system that promotes faster drying times. Some facilities use portable heating units that can be rolled into a spray booth after an object has been painted. Some spray booths draw in air through filters to assure a flow of clean air over the object to be coated, and other booths draw in air through unfiltered openings. Air is drawn out of the booth to promote drying and to provide a safer working environment for the painter by removing solvent vapors from the work area. Filters for the discharge from the booth remove coating overspray (the portion of the coating solids that does not adhere to the surface being sprayed) from the exhaust air. The three most common types of spray booths are: crossdraft, downdraft, and semi-downdraft. Crossdraft spray booths operate by pulling incoming air into the booth at one end, with air crossing over the object being coated and then passing out of the booth at the opposite end. Downdraft booths employ a vertical air flow from the top to the bottom of the booth. Because downdraft booths provide the cleanest drying/curing environment with low air turbulence and

Various forms of roll coating are the preferred techniques for applying coatings to flat woods. Coatings used for the surface cover can be applied with a direct roller coater; reverse roll coaters are generally used to apply fillers. Precision coating and printing (usually with offset gravure grain printers) are also forms of roll coating. Most inks are pigments dispersed in alkyd resin, although waterbased inks are available and are desirable because of their clarity, cost, and low environmental impact. Several types of curtain coating may also be employed (usually for topcoat application) with flat wood products. Spray techniques and brush coating may also be used. Finishing techniques are used to cover the original surface and to produce various decorative effects. Groove coatings, sealers, fillers, and topcoats may be used for this purpose. The coatings may be water- or solvent-based, catalyzed, or UV-cured.

### Materials to Coat

Due to the versatility of the invention, any number of materials may be coated and protected by the compositions of this invention. In preferred embodiments, the article to be coated is wood-containing, meaning it comprises 1% or more wood or wood-derivative.

Examples of suitable wood furniture include, but are not limited to: bookcases, boxes, cabinets (e.g., kitchen, television, and radio), chairs, desks, entertainment systems, fixtures, frames, moldings, stands, tables, paneling, partitions, and vanities.

Because UV and visible light damage is more pronounced outside, the compositions described herein find exemplary use when applied to, but not limited to: boards, building materials, decks, outside furniture, ladders, laminates, paneling, particle board, play sets, plywood, posts, railings, shingles, signs, stairs, and timber.

Despite the broad range of products manufactured by this source category, some manufacturing operations are common. There are four basic wood furniture manufacturing operations: finishing, gluing, cleaning, and washoff. Only finishing is considered a coating operation (Code of Federal Regulations [CFR], 1994). Wood furniture finishing operations include those in which a finishing material is applied to a substrate. The types of finishing materials include stains, base coats, wash coats, glazes, fillers, sealers, highlights, enamels, and topcoats that all serve different functions. The number, sequence, and type of finishing materials varies by the type and quality of the furniture being finished. All of the finishing materials may contain hazardous air pollutants that are emitted during application.

After the finishing material is applied, the wood substrate typically enters a flashoff area where the more volatile solvents evaporate and the finishing material begins to cure. Then the material enters an oven where curing of the finishing material and evaporation of the volatile solvents continues.

Facilities may finish the furniture in components and then assemble it, but more commonly, the piece of furniture is assembled and then finished. The furniture or furniture components may be moved manually from one finishing application station to the next or on tow lines that automatically move through the finishing lines. Finished furniture that does not meet specification may need to be refinished; the cured coating is removed by washing off the old coating using solvent. This process is called washoff.

In other embodiments, the objects coated and protected by the compositions are not wood-containing, but benefit from protection from UV and/or visible light. Such materials might otherwise deteriorate, discolor, fade, lose structural integrity, and/or aesthetic appeal. Without limitation, examples include: fabrics and plastics.

The invention will now be described with reference to the following examples:

### EXAMPLES

### Example 1

Formulation #1 of the invention was prepared, containing 4% (w/w) Tinuvin® 5236, 15% Microflex® NX (w/w), 50% Carbowax™ 600, and 31% water.

The formulation was applied to freshly-cut black spruce wood panels.

Panels were exposed to UV-A radiation of 340 nm for 10 hours in a laboratory.

The change in degree of yellowing (ΔE*) was measured using a CM 3610d spectrometer (Konica Minolta Holdings, Inc., Tokyo, Japan). ΔE* was measured to be 2.

### Example 2

Formulation #1 was applied to freshly-cut black spruce wood panels.

Panels were exposed for 1 year on roof-mounted weather racks in Bern, Switzerland facing southwest at a 45° angle.

After 1 year, the change in degree of yellowing (ΔE*) was measured using a CM 3610d spectrometer (Konica Minolta Holdings, Inc., Tokyo, Japan). ΔE* was measured to be 1.

After 1 year, the degree of wood destruction was observed to be 0%.

### Example 3

Formulation #1 was applied to freshly-cut black spruce wood panels. The panels were topcoated with a colorless stain; the dry-film thickness was about 50 μm.

Panels were exposed for 3 years on roof-mounted weather racks in Bern, Switzerland facing southwest at a 45° angle.

After 1 year, there was no change in the color of the coated black spruce panel. The colorless topcoat was in perfect condition, without any topcoat peel loss.

After 3 years there was no color change of the coated black spruce panel. There were minor imperfections in the colorless topcoat, and without any topcoat peel loss.

### Comparative Examples 1-4

Four comparative formulations were prepared as indicated in Table 1.

The formulations were applied to freshly-cut black spruce wood panels.

Panels were exposed to UV-A radiation of 340 nm for 10 hours in a laboratory.

The change in degree of yellowing (ΔE*) was measured using a CM 3610d spectrometer (Konica Minolta Holdings, Inc., Tokyo, Japan).

The comparative formulations provided less UV protection than the formula of the invention, as greater values of ΔE* were measured (Table 2).

TABLE 1
Formulations of Comparative Examples 1-4

| | Tinuvin ® 5236 | polyethylene | Microflex ® | | |
|---|---|---|---|---|---|
| | (w/w) | glycol (w/w) | NX (w/w) | vehicle (w/w) | total |
| Formula #1 | 4% | 50% | 15% | deionized water | 100% |
| | (microemulsion) | | | 31% | |
| Compar. formula #1 | [symbol] | [symbol] | [symbol] | deionized water | 100% |
| | | | | 100% | |
| Compar. formula #2 | 4% | 50% | 0% | deionized water | 100% |
| | (dispersed) | | | 46% | |
| Compar. formula #3 | 4% | 50% | 0% | butyl glycol | 100% |
| | (dissolved) | | | 46% | |
| Compar. formula #4 | 4% | 50% | 0% | deionized water | 100% |
| | (dispersed) | | | 46% | |

[symbol]

indicates data missing or illegible when filed

TABLE 2
ΔE* values after 10 hours of UV-A (340 nm) exposure

| example | formula | ΔE* |
|---|---|---|
| Example 1 | Formula #1 | 2 |
| Compar. Example 1 | Compar. formula #1 | 21 |
| Compar. Example 2 | Compar. formula #2 | 17 |
| Compar. Example 3 | Compar. formula #3 | 17 |
| Compar. Example 4 | Compar. formula #4 | 10 |

### Comparative Example 5-8

The four comparative formulations were applied to freshly-cut black spruce wood panels.

Panels were exposed for 1 year on roof-mounted weather racks in Bern, Switzerland facing southwest at a 45° angle.

After 1 year, the change in degree of yellowing (ΔE*) was measured using a CM 3610d spectrometer (Konica Minolta Holdings, Inc., Tokyo, Japan), and the degree of wood destruction was observed.

The comparative formulations provided less UV protection than the formula of the invention, as indicated by greater values of ΔE* and degrees of destruction (Table 3).

TABLE 3
ΔE* values and degree of destruction after 1 year outside exposure.

| | | | degree of |
|---|---|---|---|
| example | formula | ΔE* | destruction |
| Example 1 | Formula #1 | 1 | 0% |
| Compar. Example 1 | Compar. formula #1 | 19 | 50% |
| Compar. Example 2 | Compar. formula #2 | 17 | 10% |
| Compar. Example 3 | Compar. formula #3 | 15 | 20% |
| Compar. Example 4 | Compar. formula #4 | 11 | 10% |

### Comparative Examples 9-13

The four comparative formulations were applied to freshly-cut black spruce wood panels. The panels were topcoated with a colorless stain; the dry-film thickness was about 50 μm.

Panels were exposed for 3 years on roof-mounted weather racks in Bern, Switzerland facing southwest at a 45° angle.

The change in wood color and topcoat peel loss were evaluated after 1 year and 3 years exposure.

All comparative formulations provided less UV protection than the formula of the invention, as indicated by a yellow wood color change and topcoat peel loss. The formula of the invention retained the original wood color with minor topcoat defects, and without topcoat peel loss (Table 4).

TABLE 4
Results after 1 year and 3 years of exposure for black spruce wood panels.

| | | 1 year | | 3 year | |
|---|---|---|---|---|---|
| | | color | topcoat | color | topcoat |
| example | formula | change | peel loss | change | peel loss |
| Example 1 | Formula #1 | none | topcoat in | none | minor defects |
| | | | perfect condition | | in topcoat |
| Compar. Example 1 | Compar. formula #1 | to yellow | 15% | to grey | 90% |
| Compar. Example 2 | Compar. formula #2 | to yellow | 15% | to grey | 80% |
| Compar. Example 3 | Compar. formula #3 | to yellow | 15% | to grey | 90% |
| Compar. Example 4 | Compar. formula #4 | to yellow | 10% | to yellow | 70% |

The invention has been described in detail with particular reference to preferred embodiments thereof, but it will be understood that variations and modifications can be effected within the spirit and scope of the invention.

What is claimed is:

1. A UV-protecting composition that comprises at least: (a) a UV absorber, (b) a microemulsifier, (c) a polyol, and (d) a water-based vehicle.

2. The composition of claim 1 wherein said UV absorber is selected from the group consisting of: a triazine UV absorber, a benzotriazole UV absorber, and blends thereof.

3. The composition of claim 2 wherein said triazine UV absorber is present from about 1% (w/w) to about 10% (w/w).

4. The composition of claim 2 wherein said triazine UV absorber is Tinuvin® 477.

5. The composition of claim 2 wherein said benzotriazole UV absorber is present from about 1% (w/w) to about 10% (w/w).

6. The composition of claim 2 wherein said benzotriazole UV absorber is selected from the group consisting of 3-(2H-benzotriazol-2-yl)-5-(1,1-dimethylethyl)-4-hydroxy-benzenepropanoic acid, C7-9-branched alkyl esters, C7-C9 linear alkyl esters, and blends thereof.

7. The composition of claim 2 wherein said UV absorber is Tinuvin® 5236.

8. The composition of claim 1 wherein said microemulsifier is present from about 1% (w/w) to about 30% (w/w).

9. The composition of claim 1 wherein said microemulsifier is selected from the group consisting of: Microflex® NX, maleated linseed oil, and blends thereof.

10. The composition of claim 1 wherein said polyol is present from about 1% (w/w) to about 60% (w/w).

11. The composition of claim 1 wherein said polyol is selected from the group consisting of: ethylene glycol, glycerol, methoxy-poly(ethylene glycol), poly(ethylene glycol), poly(ethylene glycol methacrylate), propylene glycol, sorbitol, and blends thereof.

12. The composition of claim 11 wherein said poly(ethylene glycol) has a molecular weight from about 100 amu to about 1000 amu.

13. The composition of claim 1 wherein said water-based vehicle comprises at least 10% water.

14. A composition for protecting lignin from UV radiation that comprises at least: (a) a UV absorber, (b) a microemulsifier, (d) a polyol, and (d) a water-based vehicle.

15. The composition of claim 14 wherein said UV absorber is selected from the group consisting of: a triazine UV absorber, a benzotriazole UV absorber, and blends thereof.

16. A primer coating having the composition of claim 1 or claim 14.

17. The primer coating of claim 16 that additionally comprises an ingredient selected from the group consisting of: an acid, an anti-foamer, a bactericide, a base, a colorant, a defoamer, an emulsifier, a fungicide, a lubricant, a plasticizer, a solvent, a UV absorber, a wax, and blends thereof.

18. The primer coating of claim 16 that is applied at a use level from about 2 grams per square meter to about 20 grams per square meter.

19. A method for protecting wood and/or lignin from UV degradation that comprises:
(I) selecting a composition that comprises at least: (a) a UV absorber, (b) a microemulsifier, (c) a polyol, and (d) a water-based vehicle; and
(II) applying said composition on a substrate at a use level from about 2 grams per square meter to about 20 grams per square meter.
